(19) United States
(12) Patent Application Publication
(10) Pub. No.: US 2016/0038815 A1
(43) Pub. Date: Feb. 11, 2016

(54) COUNTER CURRENT SWIMMING APPARATUS

(71) Applicant: Aquatic Research and Training Technology LLC, Meansville, GA (US)

(72) Inventors: Eric Snell, Meansville, GA (US); Warren Snell, Meansville, GA (US)

(73) Assignee: AQUATIC RESEARCH AND TRAINING TECHNOLOGY LLC, Meansville, GA (US)

(21) Appl. No.: 14/819,056

(22) Filed: Aug. 5, 2015

Related U.S. Application Data
(60) Provisional application No. 62/033,888, filed on Aug. 6, 2014.

(51) Int. Cl. A63B 69/12; G08B 3/00; G01P 5/00; G08B 5/00; E04H 4/12; E04H 4/14

(52) U.S. Cl. CPC A63B 69/125; E04H 4/12; E04H 4/14; G01P 5/00; G08B 5/00; G08B 3/00

(57) ABSTRACT

A counter current swimming apparatus having a tank, first and second water propulsion systems and a computer. The tank is adapted to contain water. The first water propulsion system is positioned about a first end of the tank for generating a current in a first direction and the second water propulsion system is positioned about a second end of the tank for generating a current in a second direction opposite the first direction. The computer is operatively connected to the first and second water propulsion systems and configured to cause the first water propulsion system to generate the current in the first direction, and suspend operations of the first water propulsion system and initiate operations of the second water propulsion system to generate the current in the second direction upon receipt of a transition signal from a push plate of the first water propulsion system.

### CROSS REFERENCE TO RELATED APPLICATIONS

The present application claims the benefit of U.S. Provisional Patent Application No. 62/033,888 filed Aug. 6, 2014 entitled “Swimming Training and Therapeutic System,” the entire disclosure of which is incorporated by reference herein.

### BACKGROUND OF THE INVENTION

The present invention relates in general to counter current, continuous swimming apparatuses with improved capabilities for exercise, training, and therapy. Users swim against a generated current of water, which is adjusted by the apparatus according to predetermined and preset intervals to more rigorously exercise the user. An opposing means of generating current within the apparatus can be used to further simulate a full length pool, allowing for turns and a simulated pool of a certain distance.

Counter current, continuous swimming machines are able to simulate long distances for swimmers in relatively small pools, but they fail to simulate a pool of a specific length or provide variation in exercise functions necessary for a more complete exercise for therapeutic or training purposes. These machines also fail to train users for competition dives or turn maneuvers, crucial components in competition swimming, and modern continuous swimming machines have limited use in competitive swimming.

Examples of existing art regarding continuous swimming methods are limited to the methods of generating current. U.S. Pat. No. 5,044,021—Murdock is one example of a counter current swimming apparatus with efficient current generation and a focus on the current relative to the user. However, this method only allows distance swimming at a set velocity.

U.S. Pat. No. 7,526,820—Murdock is a moveable counter current swimming machine that produces current velocities that can be remotely changed, though this must be done by the user while swimming or the user must stop swimming to change the current velocity.

None of these methods provide a preset method for variable swimming exercise in velocity nor have the ability to accurately simulate a pool of a specific and limited length for training. Training competitive turns and dives in these smaller pools could be extremely dangerous.

### BRIEF SUMMARY OF THE INVENTION

In accordance with a preferred embodiment, the present invention provides a counter-current swimming apparatus that includes a tank, a first water propulsion system, a second water propulsion system, a push plate adjacent each of the first and second water propulsion systems, and a computer. The tank is adapted to contain water and includes a first end and a second end opposite the first end. The first water propulsion system is positioned about the first end of the tank for generating a current in a first direction. The second water propulsion system is positioned about the second end of the tank for generating a current in a second direction opposite the first direction. The push plates are operatively connected to the computer and transmits a transitional signal. The computer is operatively connected to the first and second water propulsion systems and includes a non-transitory computer readable medium including computer instructions that, when executed by a processor cause the first water propulsion system to generate the current in the first direction, and suspend operations of the first water propulsion system and initiate operations of the second water propulsion system to generate the current in the second direction upon receipt of a transition signal. The non-transitory computer readable medium further includes instructions to adjust a flow rate of the current generated by the first or second water propulsion systems at predetermined intervals.

The counter-current swimming apparatus further includes an indicator operatively connected to the computer for indicating a change in a velocity of flow or direction of the current, a tracking system operatively connected to the computer for tracking a position of a user, a tether attached to one of the first or second ends of the tank, and/or a push plate adjacent each of the first and second water propulsion systems. The push plate is operatively connected to the computer and generates the transition signal. The push plate generates the transition signal upon contact by the user. The push plate includes a plurality of through holes. The indicator is an auditory, visual or tactile indicator. Furthermore, the counter-current swimming apparatus includes instructions to adjust the rate of flow or direction of the current based upon a tracked position of the user.

In sum, the present embodiment provides a counter-current swimming apparatus that includes a tank, a first water propulsion system, a second water propulsion system, a tracking system, a computer, and an indicator. The tank is adapted to contain water and includes a first end and a second end opposite the first end. The first water propulsion system is positioned about the first end of the tank for generating a current in a first direction. The first water propulsion system includes a first push plate that generates a first transitional signal upon contact by a user. The second water propulsion system about the second end of the tank for generating a current in a second direction opposite the first direction. The second water propulsion system includes a second push plate that generates a second transitional signal upon contact by the user. The tracking system tracks a position of the user within the tank. The computer is operatively connected to the first and second water propulsion systems and the tracking system. The computer includes a non-transitory computer readable medium including computer instructions that, when executed by a processor cause the first water propulsion system to generate a current in the first direction, suspend operations of the first water propulsion system and initiate operations of the second water propulsion system to generate a current in the second direction upon receipt of first transition signal, and adjust a flow rate of the current generated by the first or second water propulsion systems at predetermined intervals based upon a tacked position of the user within the tank. The indicator is operatively connected to the computer for indicating a change in a velocity of flow or direction of the current.

The indicator is positioned within or along a bottom surface of the tank and can be an auditory, visual, tactile indicator or a movable T-shaped image.

The counter-current swimming apparatus may further includes a tether attached to one of the first or second ends of the tank to restrict movement of a user in the first or second directions.

In accordance with another preferred embodiment, the present invention includes a counter current swimming apparatus comprising a tank adapted to contain water, a first water propulsion system, a second water propulsion system, a tracking system for tracking a position of the user within the tank, and a computer operatively connected to the first and second water propulsion systems and the tracking system. The tank includes a first end and a second end opposite the first end. The first water propulsion system is about the first end of the tank for generating a current in a first direction. The second water propulsion system is about the second end of the tank for generating a current in a second direction opposite the first direction. The tracking system tracks a position of the user within the tank. The computer is operatively connected to the first and second water propulsion systems and the tracking system. The computer includes a non-transitory computer readable medium including computer instructions that, when executed by a processor cause the first water propulsion system to generate a current in the first direction, the second water propulsion system to generate a current in the second direction, and the first or second water propulsion systems to adjust a flow rate of the generated current at predetermined intervals based upon the tracked position of the user within the tank. The counter current swimming apparatus further includes an indicator operatively connected to the computer for indicating a change in a velocity of flow or direction of the current.

In accordance with yet another preferred embodiment, the present invention provides counter current swimming apparatus that includes a tank, a water propulsion system, a tether and a computer. The tank is adapted to contain water. The water propulsion system about a first end of the tank for generating a current in a first direction. The tether includes a first end attached to the first end of the tank and second end opposite the first end for attaching to a user. The computer is operatively connected to the water propulsion system. The computer includes a non-transitory computer readable medium including computer instructions that, when executed by a processor cause the water propulsion system to generate the current in the first direction, and suspend operations of the water propulsion system upon reaching a predetermined interval. The counter current swimming apparatus further includes an indicator operatively connected to the computer for indicating a change in a velocity of flow of the current. The indicator is an auditory, visual, tactile indicator or a moving T-shaped image. The counter current swimming apparatus further includes a tracking system operatively connected to the computer for tracking a position of a user.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a side view of a counter current swimming apparatus in accordance with a preferred embodiment of the present invention;

FIGS. 2-1 through 2-5 are side views of the counter current swimming apparatus of FIG. 1 showing a swimmer using the system;

FIGS. 3-1 through 3-2 are side views of the counter current swimming apparatus of FIG. 1 in accordance with another aspect of the present embodiment;

FIGS. 4-1 through 4-2 are side views of the counter current swimming apparatus of FIG. 1 in accordance with yet another aspect of the present embodiment; and

FIG. 5 is a top plan view of the counter current swimming apparatus of FIG. 1 in accordance with another aspect of the present embodiment.

### DETAILED DESCRIPTION OF THE INVENTION

Reference will now be made in detail to the preferred embodiments of the invention illustrated in the accompanying drawings. Wherever possible, the same or like reference numbers will be used throughout the drawings to refer to the same or like features. It should be noted that the drawings are in simplified form and are not drawn to precise scale. In reference to the disclosure herein, for purposes of convenience and clarity only, directional terms such as top, bottom, above, below and diagonal, are used with respect to the accompanying drawings. The term “proximal” shall mean towards the center of an object. The term “distal” shall mean away from the center of an object. Such directional terms used in conjunction with the following description of the drawings should not be construed to limit the scope of the invention in any manner not explicitly set forth.

Certain terminology is used in the following description for convenience only and is not limiting. The words “right,” “left,” “lower” and “upper” designate directions in the drawings to which reference is made. The words “inwardly” and “outwardly” refer to directions toward and away from, respectively, the geometric center of the identified element and designated parts thereof. Additionally, the term “a,” as used in the specification, means “at least one.” The terminology includes the words noted above, derivatives thereof and words of similar import.

As used herein, “fluid substances” refers to any fluid that can support exercise, such as swimming or physical therapy, with higher resistance to exercise than air. Substances could include treated water found in swimming pools; other “fluid substances” could include substances with a higher density than water. Fluids with a higher density than water provide higher resistance and better exercise and could be ideal as part of the technology described herein.

A “current generator,” as used herein, refers to a mechanism capable of propelling fluid substances in a relatively uniform direction. The term “counter-current” as used herein generally refers to a current that is resistive to the user's net force or direction of travel. As used herein, the term “current adjustment” refers to any process of altering resistive current in relation to the user's motion with respect to the resistive forces on the user. Examples of “current adjustment” include changes to a current generator's motor output, hydraulic power output, orifice(s) sizing, directionality, and/or baffling or diversion of portions of the current in relation to the user.

As used herein, “user motion” includes any intentional movement by the user within the fluid substance. Possible examples of “user motion” could include swim training for lap pools as well as physical therapy, such as on a submerged treadmill or resistive muscle conditioning.

The concept of “lap pool training” as used herein is the repeated and continuous swimming of a specific length of pool wherein the user must reverse swimming direction by propelling off the walls of the pool. One of the uses for the present invention is the simulation of competitive lap pool swimming in pools with a length shorter than most competition pools. Therefore, the term “lap pool training” in some embodiments described herein can pertain directly to the process of training users through the simulation of a competitive lap pool. Terms directly related to “lap pool training”, as used herein includes “transition phase,” and “indication means.”

As used herein, “transition phase” pertains to a change in the direction of user motion. One example of a “transition phase” as pertaining herein to lap pool training would include the process of a user-engaged transition of direction such as a flip-turn on a simulated pool wall.

As used herein, “change indicator” or “indicator” includes any systems, processes, and/or apparatuses used to signify and/or indicate changes and/or transitions in the current and/or other aspects of the system that require a response by the user. Examples of potential “change indicators” include visual signals such as lights which indicate upcoming and immediate changes to the current. Alternatively, the change indicator can be an auditory device, or a tactile signal generator. Potential uses of various “change indicators” can include the indication of a future transition phase or the initiation and/or termination of exercise in the current such as a start and/or finish of a preprogrammed exercise sequence. An example of a competitive swim training ‘indicator’ would be a light panel or screen on the bottom that simulates the tile line in the center of the floor of a pool lane wherein the tile line converts to a ‘T” shape just prior to the termination of the current. Such a system will accurate simulate the same warning a competitive swimmer would encounter in a typical competitive race pool.

“Performance analysis” generally refers to a digital or electronic analysis of the combined user motions and/or user interactions with the current. Examples of performance analysis as related to competitive swim training would include data from motion sensing apparatuses of swimmer technique/form, position in current, or modifications to the current. An expert could thereby monitor if a swimmer is able to maintain form and/or technique within a particular sequence of exercise. An example of “performance analysis” pertaining to physical therapy can include similar analysis parameters which can be compiled to monitor the conditioning and/or improvement involved in therapy exercises.

“Preprogrammed interval(s)” pertains to the ability to adjust the counter current resistive force on the user at predetermined intervals based on time or fluid displacement for the purpose of providing a continuous series without requiring user input during the “preprogrammed interval(s).”

In accordance with a preferred embodiment, the present invention provides a counter current swimming apparatus 100, as shown in FGIS. 1 through 4-2. The swimming apparatus 100 pertains to physical therapy, general exercise, competitive lap pool training, triathlon training, and many other forms of exercise and therapy. The included figures show a preferred embodiment with respect to competitive lap pool swimming.

The swimming apparatus 100 include a tank 1 configured and adapted to contain water, such as pool water or salt water. The tank 1 includes a first end and a second end opposite the first end. For example, the tank can be a rectangular prism tank and the first end is at one width end of the rectangle prism and the second end is at the opposite width end of the rectangular prism.

About the first end of the tank is positioned a first current generator or first water propulsion system 3 and about the second end of the tank is positioned a second water propulsion system 7. The first and second water propulsion systems can be any water propulsion system used in conventional swimming apparatus such as those disclosed in U.S. Pat. Nos. 5,044,021; 7,526,820; and 8,141,180, the entire disclosures of which are incorporated by reference herein for all purposes.

Attached to the first current generator 3 is a first push plate 12. The first push plate 12 is attached such that the first push plate faces inwardly of the tank and can be pushed by a user. Attached to the second current generator 7 is a second push plate 8 which is attached so as to face inwardly of the tank. Each of the first and second push plates is configured to be activated upon contact by the user. Up contact, the push plate via a signal generator sends a signal to a computer 200. That is, the computer is operatively connected to the first and second push plates for receiving a signal (also referred to herein as a “transition signal”) upon activation by the user.

Each push plate is generally a planar plate sized sufficiently to enable a user to make contact with it by their hands or feet, such as during a flip turn. The push plates can be porous, such as with a plurality of through holes, or non-porous. The foregoing push plates can be configured similar to conventional push plates that sends a signal, such as those disclosed in U.S. Pat. No. 7,772,512, the entire disclosure of which is incorporated by reference herein in its entirety for all purposes.

The push plate can alternatively be configured as a surface covering an entrance of the current generators for allowing a user to push off the plate with their feet when turning to leave the first current generator toward the second current generator and vice versa.

The computer 200 includes a non-transitory computer readable medium for storing computer instructions executable by a processor. Specifically, the computer readable medium includes instructions to cause the first water propulsion system to generate a current within the tank in a first direction and then suspend operations of the first water propulsion system and initiate operations of the second water propulsion system to generate a current in a second direction opposite the first direction upon receipt of a first transition signal from the first push plate. Then, upon receipt of a second transition signal from the second push plate, operations of the second water propulsion system is suspended and operations of the first water propulsion system is reinstated. Thus, in operation, only one of the first and second water propulsion systems is operated at any given time such that the current flows substantially in only one direction at any given time within the tank.

The counter current swimming apparatus also includes an indicator 5, such as an auditory, visual or tactile indicator. The indicator 5 is operatively in communication with the computer 200 and configured to activate when a velocity of flow or direction of current is changed thereby indicating to the user a change in velocity of flow or direction of the current.

The counter current swimming apparatus also includes a tracking system 300 for tracking a position of the user within the tank 1. The tracking system 300 can be e.g., a camera. Tracking systems applicable to the present embodiment are disclosed in U.S. Pat. No. 9,069,381, the entire disclosure of which are incorporated by reference herein for all purposes. The tracking system 300 is operatively connected to the computer 200 such that the computer can adjust the velocity of flow or direction of the current based upon a tracked position of the user.

The computer 200 can also be configured to include instructions executable by a processor that adjusts a flow rate of the current generated by the first or second water propulsion systems at predetermined intervals based upon a tracked position of the user within the tank. For example, the computer includes instructions to track the speed or velocity in which the user is swimming in the tank in a first direction. Then, based upon the tracked speed and time duration of the swimmer, the computer determines an overall length of travel the swimmer has swam. The speed and duration which determines the overall length of travel by the swimmer constitutes a predetermined interval which upon reaching the computer adjusts the flow rate of the counter current generated by one of the first and second water propulsion systems, activates one of the indictors to inform the swimmer of the pending change, and then changes the direction of current generated within the tank thereby providing a counter current when the user makes a turn at an end of the tank. In doing so, the computer gradually adjusts the speed of flow of the counter current sufficiently to allow the user to effectively reach an end of the tank to execute a turn maneuver.

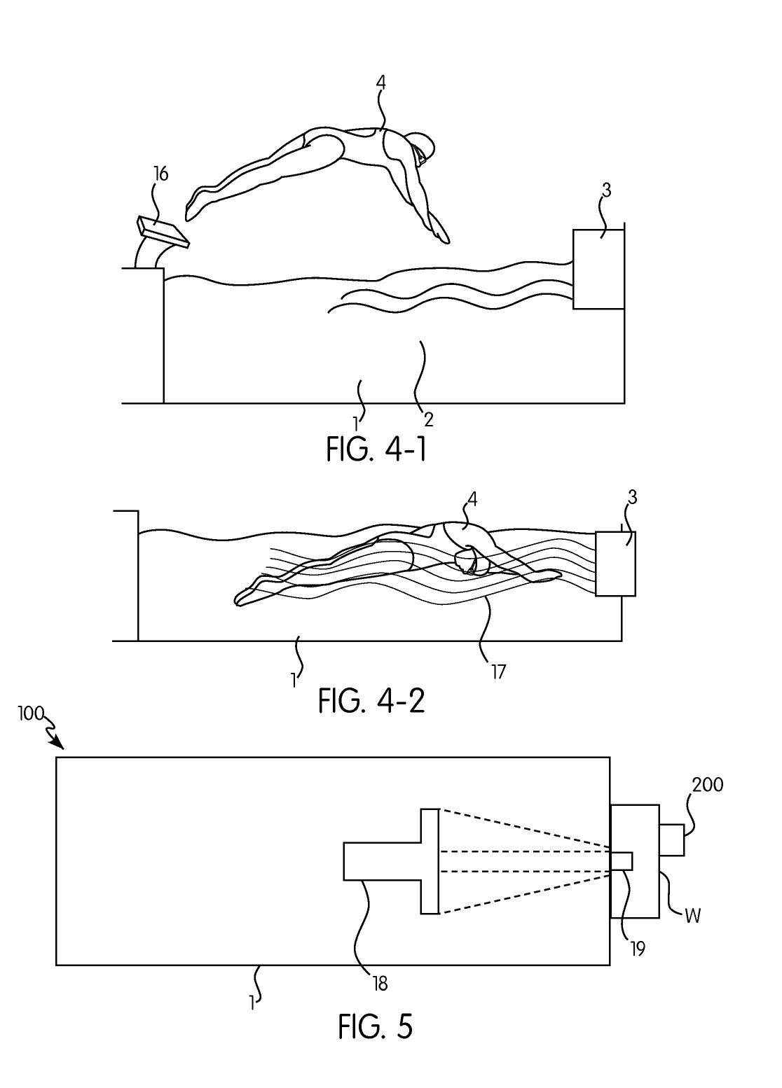

Referring to FIG. 5, in accordance with another aspect of the present invention, the indicator is shown as a moving or movable T-shaped indicator 18. The T-shaped indicator 18 is preferably a T-shaped image that moves along the length of the bottom of the tank 1 to simulate the visual indicator of a competitive swimming lane marked by appropriate tiles or paint at the bottom of a pool. The T-shaped image 18 can be provided by projector 19 operatively connected to the computer 200 and attached e.g., to each of the first and second water propulsion systems 3, 7.

In other words, the present embodiment provides a system of counter current swimming that allows for improved exercise and more complete training. A current generator system 3 for generating a substantial counter current is located below the surface of the water in a pool large enough to allow for exercise functions of the user. The system 3 can be programmed to make specific changes in current velocity after specific intervals, which will determine the current velocity generated by the current generator(s). In operation, the system operates to change the current velocity according to preprogrammed instructions stored in the computer.

The system would be capable of simulating a pool of a specific length, using the velocity of the current and the time spent operating at any given current velocity to calculate a theoretical distance travelled. After a certain length has been reached, the system reduces the velocity of the current one direction to zero which allows the user to perform a turn maneuver off of one wall. Opposing this current generator is another current generator that activates, allowing the system to produce current in the opposite direction and increases the resistive force on the user, or the user could be slowed through other means of providing resistance. The second current could increase rapidly to a necessary velocity to slow the user after a turning maneuver and then resume programmed velocity. A push plate of enough openings as to not substantially reduce current flow and enough rigidity to support a turn maneuver without harming the user can be used to cover the current machine(s).

Alternatively, a system of elastic tethering could provide the same resistive force on a user without the need for two current generators. In such an embodiment, only a single current generator is provided within the tank in combination with the system of tethers.

The present embodiment shown in the figures allows for practicing diving maneuvers in a similar manner. The user could perform a competitive dive at the starting warning of the system, after which the system would greatly increase the current velocity of an opposing current generator to quickly reduce the user's velocity. After the user's velocity has been substantially reduced, the system would begin preprogrammed velocities. The same operation could start the user from an opposing wall, allowing for pushing off the wall.

An indicator would alert the swimmer to impending changes in current velocity or necessary maneuvers. The warnings would be readily seen, heard, or felt by the swimmer to prepare them for increases in velocity, a slower rest period, an impending turn, or other necessary notifications for an exercise set.

The counter current swimming apparatus is designed to improve counter current swimming, and its unique features/methods allow for feedback and performance analysis from professionals. A system of cameras could monitor a swimmer's use of the system and send data and video feeds to remote trainers or therapists, who could then offer feedback and adjust exercise sets from a distance using the counter current swimming apparatus.

The basic concept of the present embodiments of the invention are that they relate to competitive lap pool swimming, have preprogrammed intervals, use for interval exercise, a controlled reduction to counter current resistive force to allow for transition phases, an increase in speed to slow swimmers to appropriate speeds after a dive or other forceful maneuver (such as a flip turn from an opposing wall), a push plate over the current mechanism to provide a base for swimmers while allowing for passage of a fluid substance, a set of visual, tactile, auditory, and/or other indication means to signal swimmers of impending or present changes, and the application of two opposing counter current mechanisms to create a dual system or a means of elastic forces to decrease swimmer motion in an opposite direction of the counter current.

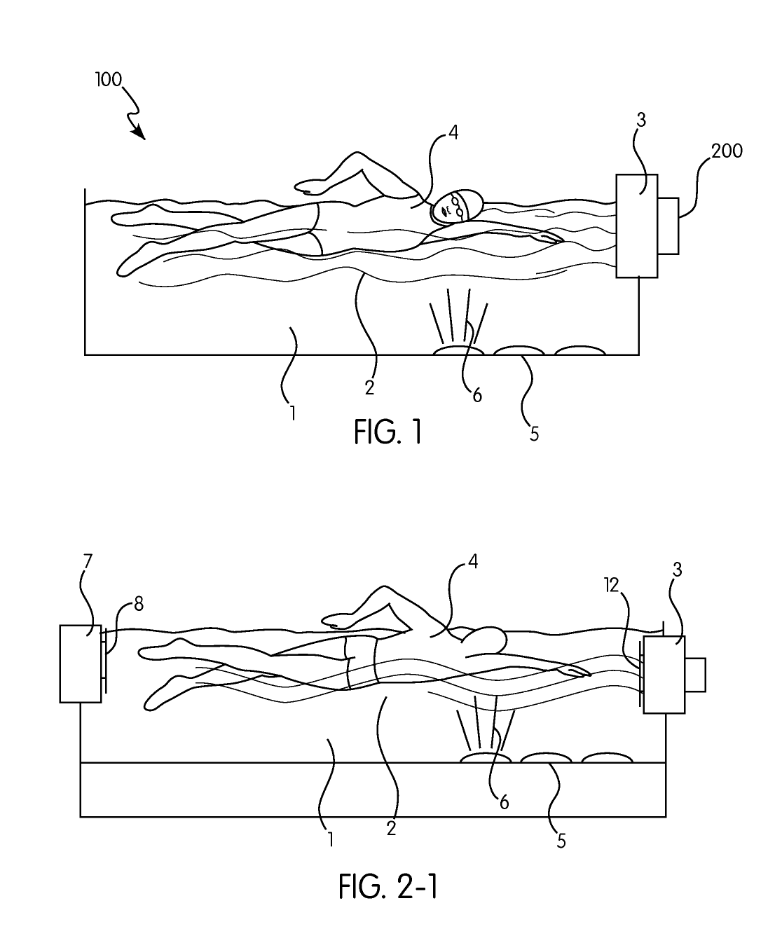

FIG. 1 illustrates a typical embodiment of this disclosure as it pertains to competitive lap pool training. The user 4 interacts with the fluid substance by swimming counter to the current 2 generated by the current generator 3. One example of an indicator 5 as depicted in FIG. 1 is the use of lights 6 to signal the present state of the counter current system, shown in Position 1.

FIG. 1 illustrates a lateral view of the technology in use showing a user swimming against a generated and controlled flow of water with an indicator (example herein is a three stage light) transmitting present or operational status. The view in FIG. 1 depicts an example of a possible indicator entailing variable lights that alert the swimmer to a continuous flow phase of swimming (lights in Position 1).

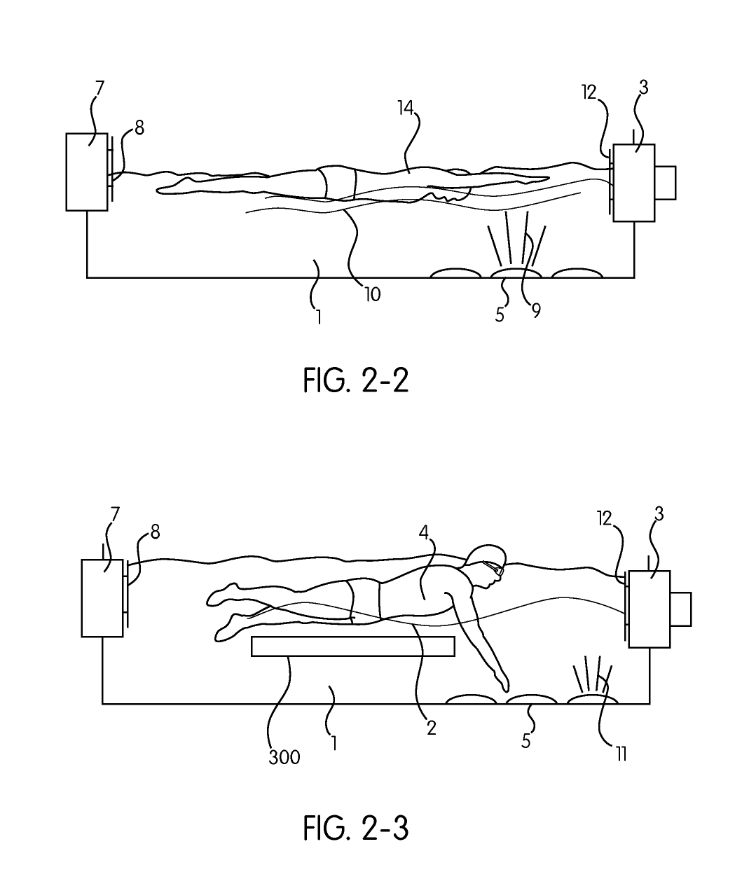

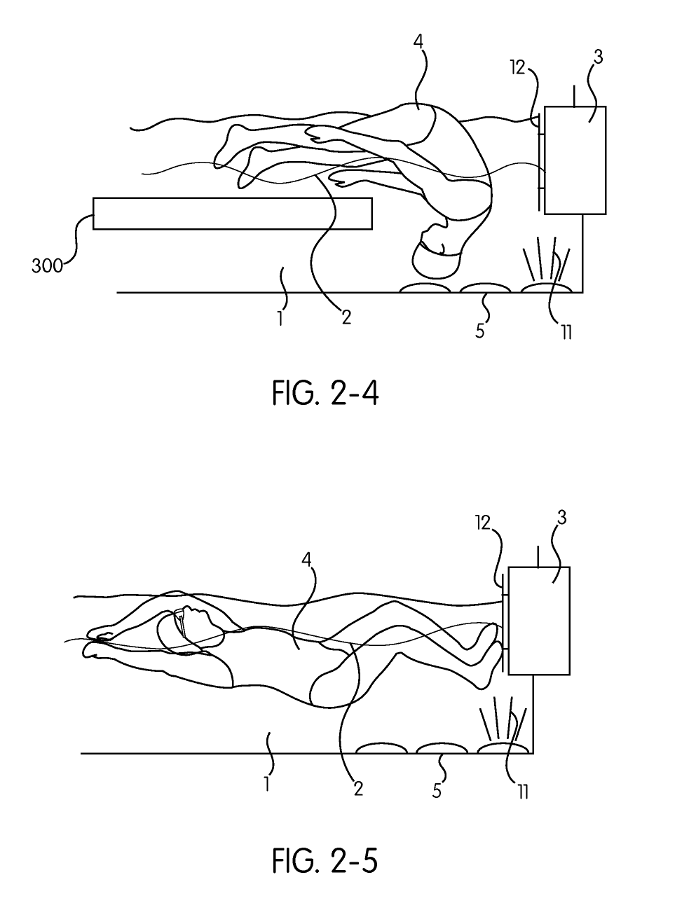

FIGS. 2-1 through 2-5 depict a transition from a continuous counter current swimming (FIG. 2-1) to a similar counter current in an opposite direction (FIG. 2-5). The transition phase begins with the indicator in Position 1 and then transitions to a transition/warning phase (FIG. 2-2) to alert the swimmer of upcoming minimal or zero counter current (FIG. 2-3). The generated flow changes with the indications of the representative light system, allowing the user to safely respond the changes in the counter current over time. FIG. 2-3 depicts the initiation of a competitive turning maneuver (transition phase) at the prompting of the indicator (Position 3), and FIG. 2-4 depicts the continuation of this maneuver in minimal or zero counter current. FIG. 2-5 illustrates the end of the transition phase, as the user is prepared to propel from the push plate covering the current mechanism.

As the user propels off of the push plate in FIG. 2-5, an opposing current generator is activated (FIG. 3-1). The counter current provides adequate resistive force to decrease the user's initial velocity to match the predetermined counter current. The processes and transition phase depicted in FIGS. 2-1 through 2-5 could be repeated to continue on preprogrammed intervals.

The first illustration (FIG. 2-1) of the five part FIG. 2 illustration series depicts the same key elements as FIG. 1. However FIG. 2-1 also contains a second current generator 7 that is presently shown in a minimal or zero current production phase relative to the user. As the preprogrammed interval in FIG. 2-2 prepares to initiate change the indication means would also change 9 as the counter current resistive force decreases to a lower resistance 10. Once the counter current resistive force decreases to a minimal or zero current, as shown in FIG. 2-3, adequate to allow a transition phase, the user initiates an appropriate change in user motion at the signal of the indicator 11, as shown in FIG. 2-4. As required for competitive lap pool training, the user is able to propel off of the push plate 12 in a manner consistent with training for turn maneuvers in lap pool competitions, as shown in FIG. 2-5.

Alternatively, as shown in FIGS. 3-1 through 3-2, a system of tethering with the user attached to a support system having appropriate elasticity to provide adequate elastic force on the user to decrease the user's initial velocity to a desired velocity can be used with a single current generator. The user could then change directions to face the original current generator and continue on preprogrammed intervals.

FIG. 3-1 through 3-2 depict a possible embodiment in which the user's propulsion after a turning maneuver is countered by the elastic force of an attached and secured tether. The user begins a turning maneuver in the depicted minimal current and propels off of the push plate. The elastic tethers provide substantial resistive force to cease the user's motion before impact with an opposing wall. The user is then able to reposition themselves to begin exercise into the counter current again.

FIG. 3-1 shows similar concepts as the illustrations in FIG. 2, providing an alternative embodiment with elastic tether lines 13 attached to the swimmer 14 and secured 15. The user may initiate a turning maneuver (FIG. 2-1) and proceed to propel from the push plate; as the user leaves the grate and pushes towards an opposing wall (FIG. 3-2), the tether system provides resistive force to prevent collisions.

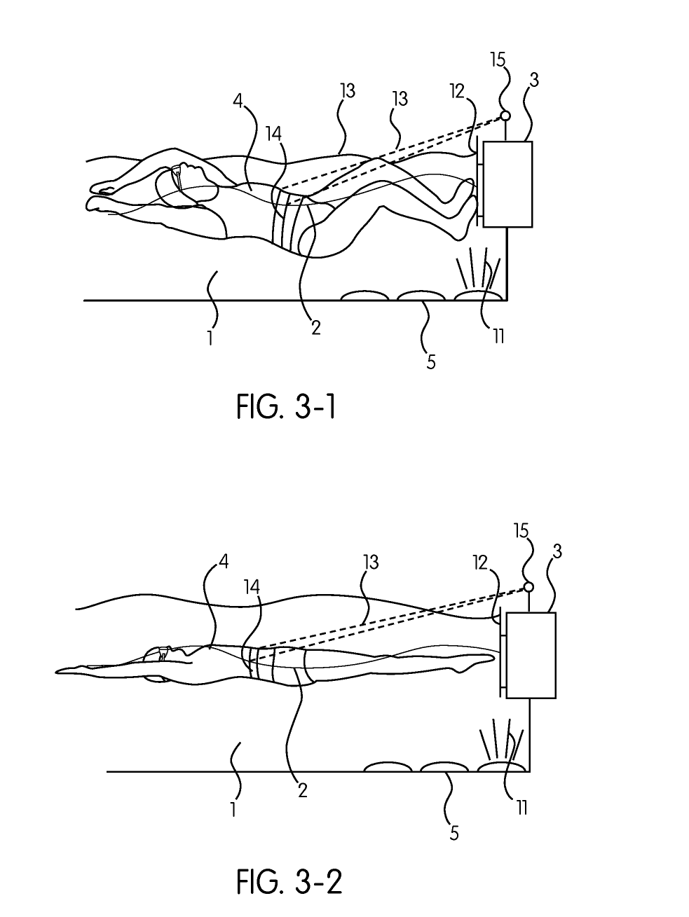

FIGS. 4-1 and 4-2 depict the sequences involved in a diving maneuver from the starting position opposite a current generator. FIG. 4-1 shows the initiation of a diving sequence and FIG. 4-2 shows the increased counter current generated by the technology to slow the user to a standard velocity during the diving maneuver.

The sequence of FIG. 4 portrays a possible means of facilitating competitive diving maneuvers with the system. FIG. 4-1 illustrates the user initiating a diving maneuver from a starting location 16 into the counter current. The counter current increases 17 to provide substantial resistive force to prevent the user from colliding into the push plate and current generator.

The overall resistive force of the counter current for general exercise or therapy could be increased or decreased based on the continuing needs of the user and force could periodically be increased for exercises. The speed of the current or displacement of the fluid substance could dictate a particular distance for varying the intensity of the workout. By intermittently using intervals of higher and lower counter current resistive force, the system would provide a more vigorous exercise system for the cardiovascular and muscular systems. Specific distances could be programmed for unique sets of exercise based upon the counter current speed or fluid substance displacement. Competitive swimmers require this variation to fully exercise and prepare for competition. These preprogrammed intervals could be customized and loaded into the system to predetermine its operation, allowing sets to be changed and fine tuned for each individual swimmer, more fully covering the needs of the swimmer.

After a given derived distance, the system could reduce the counter current resistive force to allow the swimmer to approach a push plate and engage a competition turn. The push plate covering the current generator will allow the swimmer to approach the wall as the counter current is reduced and perform a turning maneuver, using the push plate as a base. The preprogramming of the technology could be used to create a pool length of a particular distance. For instance, a counter current generator in a pool of any length could run for a derived or calculated fifty meters then initiate the turning sequence to simulate a competitive fifty meter pool. A current generator on the opposing end of the pool could be activated through a particular means and preprogrammed to simulate an additional length.

With the technology, the ability to perform competitive dives could be preprogrammed. The counter current resistive force could be preprogrammed to match the force and velocity of an individual swimmer's dive. The counter current resistive force can then be increased or decreased once the swimmer has reached zero velocity to match the preprogrammed intervals and velocities.

The combination of preprogrammed variable dive/entry speeds, derived and preprogrammed pool length (based on the counter current force and the time in activation or fluid displacements), the ability to alter counter current resistive force on the user in a preprogrammed manner, the indication means, the ability to execute turning maneuvers, the ability to counter the propulsive force of the user off the push plate, and the ability to continue on preprogrammed intervals can accurately create a simulation of any pool length and swim rate to consistently replicate any competitive lap pool condition desired. For instance, a swimmer could preprogram conditions equivalent to the speed and length of an Olympic competition. Equally, a swimmer could preprogram a near endless list of conditions for training at all levels. With the training system, the user is provided with the ability to constantly adjust, improve, and challenge training levels. Aerobic and muscle toning workouts could be greatly improved with such computer programming by varying intensity throughout a training cycle. Physical therapy, to address various handicaps or physical impairments, can be incorporated into computer training models along with the aforementioned feedback sensors to ensure a productive exercise program with built in safety features to shut down in the event of a problem with the physical therapy patient.

There are numerous potential indication means for said technology. Said indication means could include auditory, tactile, and/or visual warning means that operate in relation to the counter current. Such indication means would signal the user as to any changes, such as an increase in speed, a reduction in speed to allow for turns, a reduction to a slower pace, and/or any other present or future change to the counter current resistive force. One embodiment could include a visual system of light within vision of the user, such as below and above, wherein said light(s) perform as indicator means by means of intermittent luminescent intervals, color of the light(s), and/or multiple light position(s). Further possible embodiments of a visual indication means could include the movement of visible physical objects, visual screens or projection screens, and/or other means of producing and altering visible symbols. Because many full length lap swimming pools have visible T-shaped visuals on the pool bottom to signal proximity to a wall, a visible T-shaped visual capable of moving with the water velocity to simulate a swimmer's approach to a wall could further simulate a lap swimming pool. An auditory indication means may include, but not being limited or constrained to, an underwater speaker that emits a series of distinguishable sounds each with a specific reference to a change in the system. These auditory indication means could be used in conjunction with other indication means, warning swimmers of more minor increases or decreases in speed involved in specific training sets. A tactile system could also possibly used, in which a remotely or otherwise controlled device would be capable of direct connection to the swimmer and relate changes through a specific set of distinct physical or tactile movements or interactions with the swimmer. Auditory indication means such as speakers and/or visible symbol indication means such as liquid-crystal displays could be most practical in competitive swim training wherein the user can be regularly informed of future changes to the counter current and/or exercise parameters.

The indication means of the disclosed technology would extend to target location markers to identify ideal locations and/or other locations involving the swimmer's orientation in the fluid substance. The center of the counter current could be marked as to keep user oriented in an optimal location. The perpendicular edge of the fluid substance tank (the wall, push plate) could be marked to show the ideal location for turning maneuvers. For diving purposes a means of marking the ideal location for dive entry could be visible to swimmers preparing to initiate a competitive diving sequence. These could act as target areas for the appropriate swimming maneuver. Each target could be visuals, such as paint, grooves, designs, lights, or other physical markers. These targets could also be a system of lights that work in conjunction with the rest of the system, turning on only when necessary and turning off when unneeded. The competitive swimming stroke defined as “backstroke” offers a small challenge to counter current swim machines in that a swimmer can struggle to maintain a proper center line within the counter current and the swimmer may overpower the counter current and impact the perimeter or the current generator. This issue can be resolved through the use of a variety of overhead, mounted visual apparatuses to properly orient the swimmer. Additional safety precautions could be added to the technology, such as cushioning devices to protect the user if/when the user impacts the current generator and/or perimeter.

The disclosed technology could allow for performance analysis in a diverse selection of means. Cameras could be located above, below, to the sides, front, and/or back of the swimmer to allow trainers and/or computer programs to analyze the performance of the strokes, techniques, or condition of the user. This method would provide more detailed analysis than a single trainer physically watching a swimmer, especially paired with other sensors that could collect data on forces applied by the swimmer or the speed of specific maneuvers. Pressure sensors on dive plates could collect data on the length of time a swimmer takes to dive into the water when paired with an automatic starting system, and similar sensors on the wall or push plate could collect data with cameras on the speed and efficiency of turning maneuvers.

Through a combination of various sensor and data collection means, built into the disclosed technology or otherwise, and/or user input, a computer program can process unique user maximum performance levels for a given stroke on a given distance or for a given competitive event. These preset user condition and performance levels could be used by the computer program to determine unique time and distance intervals that are based on a percentage speed of the user's maximum abilities. Exercise parameters could include specific percentages of unique user performance levels, allowing for the automation of certain training conditions.

The disclosed technology can best culminate with the collaboration of a remote trainer wherein some of the data, such as video, motion sensors, and performance analysis, can be made available to an off-site trainer through streamed data files or saved and shared data files. The remote trainer can facilitate improvement in technique or muscular capability through analysis of said data and modification of the user's future training sets for personalized exercise.

It will be appreciated by those skilled in the art that changes could be made to the embodiments described above without departing from the broad inventive concept thereof. It is to be understood, therefore, that the present invention is not limited to the particular embodiments disclosed, but it is intended to cover modifications within the spirit and scope of the present invention as defined by the appended claims.

What is claimed is:

1. A counter current swimming apparatus comprising:
a tank adapted to contain water, the tank having a first end and a second end opposite the first end;
a first water propulsion system about the first end of the tank for generating a current in a first direction;
a second water propulsion system about the second end of the tank for generating a current in a second direction opposite the first direction;
a push plate adjacent each of the first and second water propulsion systems and configured to transmit a transition signal;
a computer operatively connected to the first and second water propulsion systems and the push plates, wherein the computer includes a non-transitory computer readable medium including computer instructions that, when executed by a processor cause
the first water propulsion system to generate the current in the first direction, and
suspend operations of the first water propulsion system and initiate operations of the second water propulsion system to generate the current in the second direction upon receipt of the transition signal from one of the push plates.

2. The counter current swimming apparatus of claim 1, wherein the non-transitory computer readable medium further includes instructions to adjust a flow rate of the current generated by the first or second water propulsion systems at predetermined intervals.

3. The counter current swimming apparatus of claim 1, further comprising an indicator operatively connected to the computer for indicating a change in a velocity of flow or direction of the current.

4. The counter current swimming apparatus of claim 3, wherein the indicator is an auditory, visual or tactile indicator.

5. The counter current swimming apparatus of claim 1, further comprising a tracking system operatively connected to the computer for tracking a position of a user.

6. The counter current swimming apparatus of claim 5, wherein the non-transitory computer readable medium further includes instructions to adjust the velocity of flow or direction of the current based upon the tracked position of the user.

7. The counter current swimming apparatus of claim 1, further comprising a tether attached to one of the first or second ends of the tank.

8. The counter current swimming apparatus of claim 1, wherein the push plate generates the transition signal upon contact by the user.

9. The counter current swimming apparatus of claim 8, wherein the push plate includes a plurality of through holes.

10. A counter current swimming apparatus comprising:
a tank adapted to contain water, the tank having a first end and a second end opposite the first end;
a first water propulsion system about the first end of the tank for generating a current in a first direction;
a second water propulsion system about the second end of the tank for generating a current in a second direction opposite the first direction;
a tracking system for tracking a position of the user within the tank, and
a computer operatively connected to the first and second water propulsion systems and the tracking system, wherein the computer includes a non-transitory computer readable medium including computer instructions that, when executed by a processor cause
the first water propulsion system to generate a current in the first direction,
the second water propulsion system to generate a current in the second direction, and
the first or second water propulsion systems to adjust a flow rate of the generated current at predetermined intervals based upon the tracked position of the user within the tank; and
an indicator operatively connected to the computer for indicating a change in a velocity of flow or direction of the current.

11. The counter current swimming apparatus of claim 10, wherein the indicator is positioned along a bottom surface of the tank.

12. The counter current swimming apparatus of claim 11, wherein the indicator is an auditory, visual or tactile indicator.

13. The counter current swimming apparatus of claim 11, wherein the indicator is a moving T-shaped image.

14. The counter current swimming apparatus of claim 11, further comprising a tether attached to one of the first or second ends of the tank.

15. A counter current swimming apparatus comprising:
a tank adapted to contain water;
a water propulsion system about a first end of the tank for generating a current in a first direction;
a tether having a first end attached to the first end of the tank and second end opposite the first end for attaching to a user; and
a computer operatively connected to the water propulsion system, wherein the computer includes a non-transitory computer readable medium including computer instructions that, when executed by a processor cause
the water propulsion system to generate the current in the first direction, and
suspend operations of the water propulsion system upon reaching a predetermined interval.

16. The counter current swimming apparatus of claim 15, further comprising an indicator operatively connected to the computer for indicating a change in a velocity of flow of the current.

17. The counter current swimming apparatus of claim 16, wherein the indicator is an auditory, visual or tactile indicator.

18. The counter current swimming apparatus of claim 16, wherein the indicator is a moving T-shaped image.

19. The counter current swimming apparatus of claim 15, further comprising a tracking system operatively connected to the computer for tracking a position of a user.
